(19) United States
(12) Patent Application Publication
(10) Pub. No.: US 2004/0245165 A1
(43) Pub. Date: Dec. 9, 2004

(54) Screen basket for screening suspensions

(76) Inventors: Sami Backman, Grastorp (SE); Johan Bergquist, Grastorp (SE)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/491,122

(22) PCT Filed: Sep. 26, 2002
(86) PCT No.: PCT/SE02/01754

(30) Foreign Application Priority Data
Sep. 27, 2001 (SE) 0103214-3

(51) Int. Cl. B01D 24/00

(52) U.S. Cl. 210/348

(57) ABSTRACT

A screen basket for screening suspensions, containing wearing particles, comprises a circumferential wall of a base material provided with screen passages, and a wear resistant outer layer of a material, typically chromium, which is harder than the base material and covers the circumferential wall. At least one wear-indicating layer is applied on the circumferential wall between the latter and the outer layer and adapted to indicate when at least a portion of the outer layer has been worn down to the wear-indicating layer.

### FIELD OF THE INVENTION

The present invention relates to a screen basket for screening suspensions, such as fiber suspensions containing wearing particles. The screen basket comprises as circumferential wall of a base materiel provided with screen passages, and a wear resistant outer layer of a materiel, which is harder than the base materiel and covers the circumferential wall.

### BACKGROUND OF THE INVENTION

In traditional screens with screen baskets of this kind the wear resistant outer layer usually consist of chromium and is about 150 μm in thickness, whereas the base materiel usually consists stainless steel. Thanks to the chromium layer the operation time of the screen basket is substantially prolonged before the screen basket has to be taken out of order and be provided with a new chromium layer or possibly be scrapped. Test have proved that the base materiel is worn up to six times faster than the chromium layer, and for this reason the economical advantages of having such a wear resistant outer chromium layer on the screen basket is significant.

The life time of the screen basket can be substantially prolonged by renewing the chromium layer when this has at least partially been worn down to the base materiel. However, it is difficult during operation of the screen to decide when it is time to renew the chromium layer. Since the life time of the chromium layer is affected by many process parameters, which in addition often vary during operation, in practice it is impossible to estimate the expected life time of the chromium layer. Such process parameters are concentration of wearing particles, type of particles (such as sand, fillers, shives and plastic particles), fiber concentration and flow.

Currently, the presence of a worn out chromium layer is normally not detected until the screening process has been negatively effected for example when the capacity of the screen has deteriorated or when the reject has been thickened to an unacceptable level. However, it is a great disadvantage to take the screen out of order only when the screening process has been negatively affected since it is the wearing of the base materiel of the screen basket that gives rise to such a deteriorated screening process. Thus, the screen basket first has be machined to restore the normally existing profiles of the base materiel forming the screen passages before the chromium layer can be renewed.

One way of eliminating the need for machining of the screen basket before the latter is provided with a new chromium layer is to from time to time take the screen out of order and dismount the screen basket for visual inspection of this. However, it is difficult to visually estimate the wearing of the chromium layer, since the base materiel of stainless steel has a color very similar to the color of the chromium layer. In addition, the wearing in many cases may appear uneven across the surface of the screen basket, some parts may be very worn whereas other parts may not be worn at all. Therefore, it may be difficult to visually in a correct manner estimate the wearing of the chromium layer.

One object of the present invention is to provide a screen basket of the kind discussed above, by which it is easy to estimate when the wear resistant materiel layer should be renewed without need for machining a base materiel of the screen basket.

### SUMMARY OF THE INVENTION

The objects of the present invention can be realized by a screen basket of the type discussed above in which at least one wearing indicating layer is supplied on the circumferential wall between the latter and the outer layer and adapted to indicate when at least a potion of the outer layer has been worn down to the wear indicating layer.

### DETAILED DESCRIPTION

According to one embodiment of the present invention the wear indicating layer is adapted to optically indicate when at least a potion of the outer layer has been worn down to the wear indicating layer. Preferably, the wear indicating layer has a color different from the outer layer. For example, the wear indicating layer may be black while the outer layer is bright, or vice versa. As a result, visual inspection of the wearing of the outer layer can easily be carried out. The wear indicating layer and the outer layer may advantageously consist of chromium, wherein the wear indicating layer is thinner than the outer layer. Thanks to that the wear indicating layer consist of chromium sometime may pass before a wearing through the outer layer is discovered, without risking wearing of the base materiel.

According to another embodiment of the present invention the wear indicating layer is adapted to secrete a signal substance, which may be chemical or radioactive, when at least a potion of the outer layer has been worn down to the wear indicating layer. A sensor is preferably arranged to sense the signal substance when this follows the accept flow from the screen basket. As a result, the wearing of the outer layer can be indicated during operation of the screen basket. Suitably, the wearing indicating layer includes a relatively thin chromium layer, wherein the signal substance is applied on the thin chromium layer between the latter and the outer layer, which preferably includes a relatively thick chromium layer.

According to a further embodiment of the present invention the wear indicating layer comprises a material with an electric resistance differing from the electric resistance of the outer layer. As a result, the electric resistance between the ends of the screen basket will rapidly change the outer layer has been worn out on some part of the surface of the screen basket and the exposed where indicating layer in turn starts to be all away. Thus, the wearing of the outer layer is detected through measuring of the change in the electrical resistance of the screen basket, preferably with the aid of a resistance meter adapted to measure the electric resistance between the ends of the screen basket. The wear indicating layer may include a material with an electric resistance which is lower than the resistance of the outer layer, for example a copper or silver material. A relatively thin chromium layer is suitably applied on the circumferential wall between the latter and the wear indicating layer to prevent the base material from starting to wear before a wearing through the outer layer has been detected.

In all of the above described embodiments of the present invention the outer layer suitably includes a relatively thick chromium layer, at least 100 μm in thickness, whereas the wear indicating layer suitably includes a chromium layer being at most 50 in thickness.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A screen basket for screening suspensions, containing wearing particles, comprising a circumferential wall of a base material provided with screen passages, and a wear resistant outer layer of a material which is harder than the base material and covers the circumferential wall, characterized in that at least one wear-indicating layer is applied on the circumferential wall between the latter and the outer layer and adapted to indicate when at least a portion of the outer layer has been worn down to the wear-indicating layer.

2. A screen basket according to claim 1, wherein the wear-indicating layer is adapted to optically indicate where at least a portion of the outer layer has been worn down to the wear-indicating layer.

3. A screen basket according to claim 2, wherein the wear-indicating layer has a colour that is different than that of the outer layer.

4. A screen basket according to claim 3, wherein the wear-indicating layer and the outer layer consist of chromium, wherein the wear-indicating layer is thinner than the outer layer.

5. A screen basket according to claim 4, wherein the wear-indicating chromium layer is at most 50 μm in thickness, whereas the outer chromium layer is at least 100 μm in thickness.

6. A screen basket according to any one of claims 3-5, wherein the wear-indicating layer is black whereas the outer layer is bright, or vice versa.

7. A screen basket according to claim 1, wherein the wear-indicating layer is adapted to secrete a signal substance where at least a portion of the outer layer has been worn down to the wear-indicating layer.

8. A screen basket according to claim 7, wherein the signal substance is chemical or radioactive.

9. A screen basket according to claim 7 or 8, wherein the wear-indicating layer comprises a relatively thin chromium layer, wherein a signal substance is supplied on the thin chromium layer between the latter and the outer layer, which preferably comprises a relatively thick chromium layer.

10. A screen basket according to claim 9, wherein the wear-indicating chromium layer is at most 50 μm in thickness whereas the outer chromium layer is at least 100 μm in thickness.

11. A screen basket according to any of one of claims 7-10, characterized by a sensor for sensing the signal substance when the latter follows the accept flow from the screen basket.

12. A screen basket according to claim 1, wherein the wear-indicating layer comprises a material with an electric resistance differing from the electric resistance of the outer layer.

13. A screen basket according to claim 12, wherein the wear-indicating layer comprises a material with an electric resistance, which is lower than the resistance of the outer layer.

14. A screen basket according to claim 13, wherein the wear-indicating layer comprises a copper or silver material.

15. A screen basket according to any of claims 12-14, characterized by relatively thin chromium layer which is supplied on the circumferential wall between the latter and the wear-indicating layer.

16. A screen basket according to any of claims 12-15, wherein the outer layer comprises a relatively thick chromium layer.

17. A screen basket according to claim 15 and 16, wherein the wear-indicating chromium layer is at most 50 μm in thickness whereas the outer chromium layer is at least 100 μm in thickness.

18. A screen basket according to any of claims 12-17, characterized by a resistance meter adapted to measure the electric resistance between the ends of the screen basket.
